(19) United States
(12) Patent Application Publication
(10) Pub. No.: US 2008/0169689 A1
(43) Pub. Date: Jul. 17, 2008

(54) Bicycle seat

(76) Inventor: Keng Chien-Kuo, Taipei (TW)

Correspondence Address: BIRCH STEWART KOLASCH & BIRCH, PO BOX 747, FALLS CHURCH, VA, 22040-0747, US

(21) Appl. No.: 11/654,013

(22) Filed: Jan. 17, 2007

(51) Int. Cl. B62J 1/02

(52) U.S. Cl. 297/195.1

(57) ABSTRACT

An improved bicycle seat to provide much more comforts for the rider to enjoy riding is comprised of a concave seat and a steel spring; the steel spring being adapted to the seat to allow more comfortable riding particularly for a male rider by relieving his reproductive organ from being always compressed by a tapered portion projection from the front of a seat of the prior art; a pair of resistance rods extending from the front of the steel spring to absorb vibration transmitted from rough road for the rider to clamp both rods with inner thighs while taking a sharp turn to avoid buttock from sliding out of the seat.

### FIELD OF THE INVENTION

The present invention is related to a seat, and more particularly to a bicycle seat.

### BACKGROUND OF THE INVENTION

An article published under the topic of Sex Issue in the first issue of “Bicycling” in 2005 mentioned a startling topic of “Law Should Prohibit Bicycling” authored by a nobody, Irwin Goldstein, MD in 1997 arguing that bicycling led to impotence. In, 2001 two medical doctors, Frank Sommer and Roger Minkow in their in vivo study with voluntary subjects retorted that argument. However, after these debates and studies, one thing is sure that the design of the bicycle seat will get better and healthier.

Judging from bio-dynamics, the seat is essentially to support the force applied to the rider's thighbone joints and the design of the seat will after the riding posture and comforts. Accordingly, improvement of the bicycle seat must be incorporated with the application of ergonomic engineering technology to reflect on the original design data before realizing any improvement. Complete data collection for the design becomes very critical in the post-ergonomic data integration. To improve the seat depending on the riding purpose, ergonomic data are usually retrieved from pressure experiments. Without drawings, it will be difficult to plot curve changes to result in a problem of linkage between ergonomic data and design data, thus to fail effective command of conceptualizing the appearance of and design and development of an ideal bicycle seat.

### SUMMARY OF THE INVENTION

The primary purpose of the present invention is to provide an improved construction of a bicycle seat for enjoying safer and more comfortable riding by having a concave seat adapted with a pair of metal resistance rods extending from a steel spring frame to support the seat form making the riding easier, particularly to a male rider. While taking a sharp turn, the rider may have both inner thighs to clamp against the metal rods to keep the rider's buttock from sliding out of the seat by taking advantage of counter-force produced by the metal rods.

Another purpose of the present invention is to provide an improved construction of a bicycle seat to enjoy the riding with more comforts by providing a steel spring as the frame for the seat to effective absorb the vibration transmitted from rough road.

To achieve these purpose to correct the problem of the conventional bicycle seat having a tapered object projecting from its front to cause a male rider very uncomfortable since it always compresses against the penis and testicles of the male rider, the present invention includes a concave seat adapted with a steel spring as the frame for the seat to absorb vibration transmitted from the rough road, and a pair of metal resistance rods extending from the frame to keep the buttock of the rider from sliding out of the seat by clamping both inner thighs against the rods while taking a sharp turn.

### BRIEF DESCRIPTION OF THE DRAWINGS

FIG. 1 is a perspective view of the present invention.

FIG. 2 is a bird's view of a steel spring frame in the present invention.

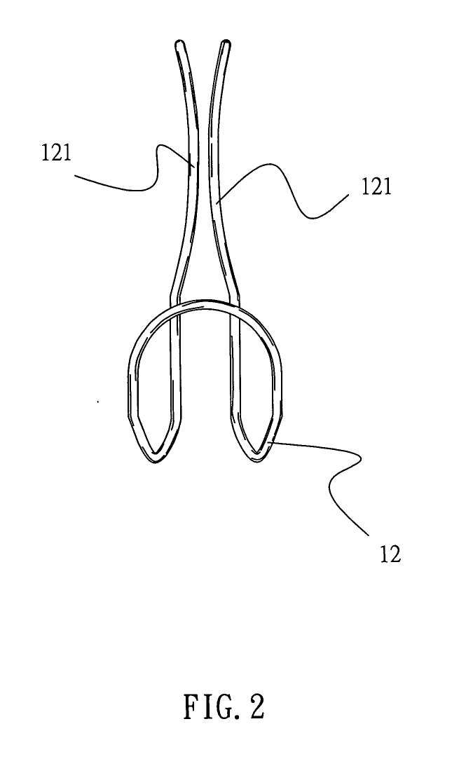

FIG. 3 is a sectional view of the steel spring frame in the present invention.

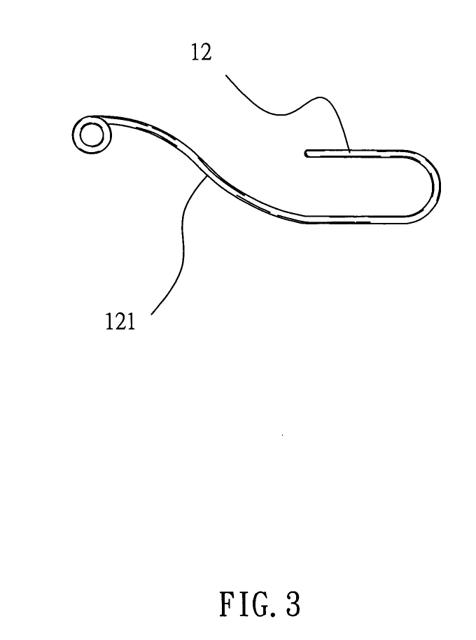

FIG. 4 is a bird's view of the present invention.

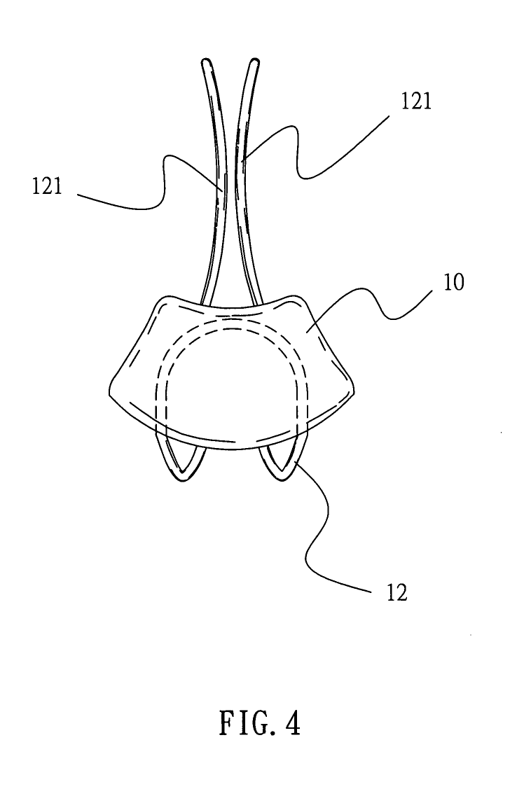

FIG. 5 is a side view of a preferred embodiment of the present invention.

### DETAILED DESCRIPTION OF THE PREFERRED EMBODIMENTS

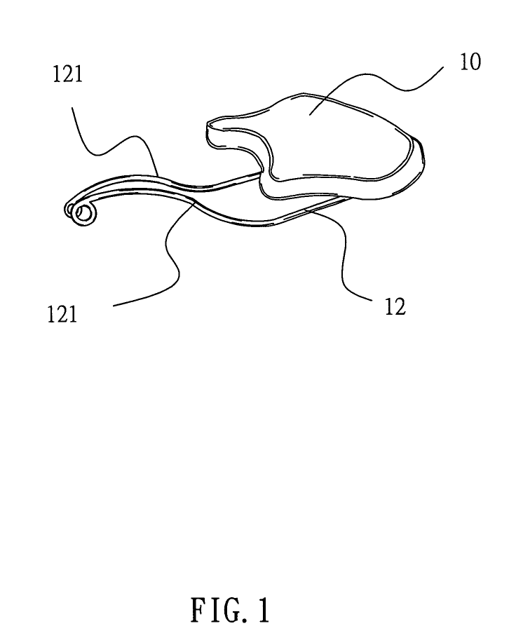

Referring to FIGS. 1 though 4, an improved construction of a bicycle seat of the present invention is comprised of a concave seat 10 without a tapered portion projecting from the front of the seat as found with the prior art so to relief the compression of the tapered portion against the reproductive organ of a male rider to compromise his riding comforts; and a steel spring 12 connected to the bottom of the seat to function as a frame to the seat. The U-shaped steel spring 12 helps firmly secure the seat 10 thereon to absorb vibration transmitted from rough road by taking advantage of dynamic compression buffering property of a steel spring material to realize more comfortable riding. A pair of metal resistance rods 121 extends from the front of the steel spring 12 attached to the bottom of the seat 10. While taking a sharp turn, the rider may have his both inner thighs to clamp against the pair of the rods 121 for producing counter-force to keep the buttock of the rider from sliding out of the seat 10 while significantly improving the riding comforts.

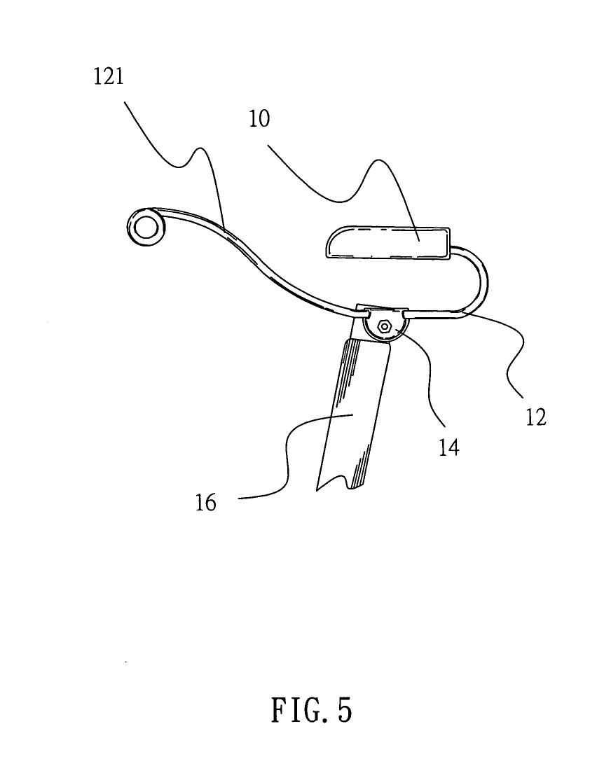

Now referring to FIG. 5 for a preferred embodiment of the present invention, a clamp 14 is connected to a tube 16, i.e., a seat tube or a brace of any other mechanical vehicle to secure the steel spring 12 in position by means of the clamp 14 for the rider to firmly sit on the seat 10. Whereas both of the steel spring 12 and the pair of metal resistance rods 121 are made of stainless steel pipe in a diameter of 0.6 cm for a significant saving of production cost in plastic raw materials and the mold development when compared to the conventional bicycle seat.

The present invention by achieving a breakthrough of the prior art has never been disclosed up to this date and is indeed meeting the requirements of advancement and utility of an invention; therefore, this application for a patent is duly filed. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention

1. A bicycle seat includes a concave seat; a seat frame comprised of a steel spring connected to the seat to absorb vibration transmitted from rough road through; a pair metal resistance rods extending from the front the of steel spring attached to the bottom of the seat for both inner thighs of the rider to clamp against them.

2. The bicycle seat as claimed in claim 1, wherein the steel spring further includes a clamp.

3. The bicycle seat as claimed in claim 2, wherein the clamp is connected to a brace disposed to the bicycle.

4. The bicycle seat as claimed in claim 1, wherein the steel spring is secured to the brace by means of the clamp.

5. The bicycle seat as claimed in claim 1, wherein both of steel spring and the pair of resistance rods are made of stainless steel.

6. The bicycle seat as claimed in claim 1, wherein the seat and the steel spring are adapted to various types of mechanical vehicle.
